(19) United States
(12) Patent Application Publication
(10) Pub. No.: US 2017/0352071 A1
(43) Pub. Date: Dec. 7, 2017

(54) SMART COST ANALYSIS OF HOUSEHOLD APPLIANCES

(71) Applicant: International Business Machines Corporation, Armonk, NY (US)

(72) Inventors: James E. Carey, Rochester, MN (US); Bryan M. Jones, Rochester, MN (US); Aditi Rajagopal, Rochester, MN (US); Ryan L. Rossiter, Rochester, MN (US)

(21) Appl. No.: 15/171,075

(22) Filed: Jun. 2, 2016

(51) Int. Cl. G06Q 30/02; H04L 12/28; G06F 17/30; H04L 12/58; G06F 17/28

(52) U.S. Cl. CPC G06Q 30/0283; H04L 51/046; G06F 17/28; G06F 17/30684; H04L 12/2825

(57) ABSTRACT

Usage data can be received by a computer system from a sensor-enabled appliance. A new appliance profile can be accessed from an external data source; the new appliance profile can contain price and energy consumption data about the new appliance. The system can also identify relational data, which can be collected from a set of sensor-enabled appliances. The relational data can be used to determine usage trends for the appliances. The usage data, new appliance profile, and relational data can then be used to determine that current usage costs exceed potential usage costs, and this determination can be transmitted to a user device.

### BACKGROUND

The present disclosure relates to sensor-enabled devices, and more specifically, to monitoring usage of the sensor-enabled devices.

Cyber-physical systems may encompass technologies including smart grids, smart homes, intelligent transportation, and smart cities. A type of cyber-physical system may include a network of physical objects including, for example, smart devices, vehicles, buildings, and other items, can be embedded with electronics, software, sensors, and network connectivity. These electronic sensors can allow objects to collect and exchange data. In some instances, the objects may be sensed and controlled remotely using, for example, existing network infrastructure.

### SUMMARY

Embodiments of the present disclosure may be directed toward a method that can receive usage data from a first sensor-enabled appliance at a server and from the first sensor-enabled appliance. The first sensor-enabled appliance may be associated with a user. Next, a new appliance profile may be accessed from an external data source. The new appliance profile may comprise price and energy consumption data about the new appliance. Relational data may be identified. The relational data may comprise data collected from a set of sensor-enabled appliances belonging to a set of users associated with the user, wherein the relational data may be used to determine usage trends for the set of sensor-enabled appliances. The system may determine current usage costs exceed potential usage costs based on the usage data from the first sensor-enabled appliance, the new appliance profile, and the relational data. The current usage costs may be a value associated with use of the first sensor-enabled appliance over a period of time and the potential usage cost is a predicted cost of using the new appliance. This determination may be transmitted to a user device.

Embodiments of the present disclosure may be directed toward a system with a computer readable storage medium with program instructions stored on the computer readable storage medium. The system may also have one or more processors configured to execute the program instructions to perform a method that includes receiving usage data for a first sensor-enabled at a server and from the first sensor-enabled appliance. The first sensor-enabled appliance may be associated with a user. The method may include accessing a new appliance profile from an external data source. The new appliance profile may include price and energy consumption data about the new appliance. Next, relational data may be identified. The relational data may include data collected from a set of sensor-enabled appliances belonging to a set of users associated with the user; the relational data may be used to determine usage trends for the set of sensor-enabled appliances. Based on the usage data for the first sensor-enabled appliance, the new appliance profile, and the relational data, the current usage costs may be determined to exceed potential usage costs. The current usage cost may be a value associated with the use of the first sensor-enabled appliance over a period of time and the potential usage cost may be a predicted cost of using the new appliance. The system may transmit the determination that the current usage costs exceed the potential usage costs to a user device.

Embodiments of the present disclosure may be directed toward a computer program product comprising a computer readable storage medium having program instructions embodied therewith. The computer readable storage medium may not be a transitory signaler per se, and the program instructions may be executable by a computer processing circuit to cause the circuit to perform a method that includes receiving usage data from a first sensor-enabled appliance at a server and from the first sensor-enabled appliance. The first sensor-enabled appliance may be associated with a user. Next, a new appliance profile may be accessed from an external data source. The new appliance profile may comprise price and energy consumption data about the new appliance. Relational data may be identified. The relational data may comprise data collected from a set of sensor-enabled appliances belonging to a set of users associated with the user, wherein the relational data may be used to determine usage trends for the set of sensor-enabled appliances. The system may determine current usage costs exceed potential usage costs based on the usage data from the first sensor-enabled appliance, the new appliance profile, and the relational data. The current usage costs may be a value associated with use of the first sensor-enabled appliance over a period of time and the potential usage cost is a predicted cost of using the new appliance. This determination may be transmitted to a user device.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a diagram of a system for notifying users of energy consumption data, according to embodiments.

FIG. 2 depicts a diagram of a system of sensor-enabled appliances, according to embodiments.

FIG. 3 depicts the representative major components of an example computer system that may be used, in accordance with embodiments of the present disclosure.

FIG. 4 depicts a flow diagram of a method for notifying users of sensor-enabled appliance energy consumption, according to embodiments.

FIG. 5 depicts a flow diagram of a method for notifying a user of a sensor-enabled appliance, based on usage data, appliance data, and friend usage, according to embodiments.

FIG. 6 depicts a cloud computing environment according to an embodiment of the present invention.

FIG. 7 depicts abstraction model layers according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to sensor-enabled appliances, more particular aspects relate to monitoring usage costs of sensor-enabled appliances. While the present disclosure is not necessarily limited to such applications, various aspects of the disclosure may be appreciated through a discussion of various examples using this context.

Electricity can be a heavily metered utility that is used by appliances in households. Cost-benefit analysis may be used when determining new appliance purchases, including deciding cost saved over time based on energy use for appliances. In embodiments, this cost-benefit analysis can include an actual financial cost. Embodiments could also include energy and time costs. In some instances, if the cost of buying a new appliance results in a savings (e.g., from energy consumption over the life of the new appliance) compared to the current appliance (e.g., from energy consumption over the life of the current appliance), a user may consider purchasing a new appliance.

In embodiments, a set of sensor-enabled appliances may be connected over a network or networks, allowing the appliances to send data, including real-time data, over the network. The appliances may transmit data to each other, to a server or servers, to another system, or elsewhere. A server may receive from a sensor-enabled appliance, usage data for the appliance. For example, a kitchen refrigerator may be sensor-enabled and connected over a network. This kitchen refrigerator may send usage data to the server. The appliance may send usage data that includes electricity consumed, usage patterns (e.g., average power consumption at a particular time of day, power consumption at a particular day of the week, peak consumption hours, or others), usage timeline (e.g., age of the appliance, how long it has been in use, how long it has been owned by the particular user). In embodiments, this system of connected sensor-enabled appliances may be a part of the internet of things, a network of physical objects that can include devices, vehicles, buildings, and other items that may be embedded with electronics, software, sensors, and network connectivity that enables the objects to collect and exchange data.

In embodiments, a new appliance profile may be accessed from a set of one or more external data sources. The new appliance profile may comprise price and energy consumption data about a new appliance. The new appliance may be a comparable replacement for the sensor-enabled appliance. For example, the new appliance may be a brand new appliance of the same variety of the appliance. The new appliance could also be a similar appliance of a different brand or from a different retailer or vendor. The new appliance could also be a used, newer or more functional appliance. The new appliance profile may be compiled using real-time data from sources accessed over the Internet or in other ways. For example, a comparable replacement for a 5-year-old kitchen refrigerator could be a brand new refrigerator of the same or a different brand. The profile for the brand new refrigerator could contain data including the current lowest retail price, data about upcoming sales for the refrigerator, manufacturer and/or consumer reviews, and other data.

In embodiments, relational data can then be identified by the system. The relational data may be received from an external system, accessed from one or more data sources, or stored within the system, for example, in memory. In embodiments, relational data may include data collected from a set of sensor-enabled appliances belonging to a set of users associated with the user. The relational data may be used to analyze and predict trends in appliance usage for a particular appliance or type of appliance. The associated users may be determined based on demographics (e.g., same age or income level as the user), social media connection (e.g., first or second degree connection on one or more social media platforms), or in another way. For example, relational data could include data collected from kitchen refrigerators from the homes in the neighborhood of the user. In other embodiments, the relational data could be data from comparable appliances in the homes of social media connections of the user. This relational data may be identified by the system. The system may also detect from the set of sensor-enabled appliances belonging to the users, a set of comparable appliances, where the comparable appliances are ones comparable in, for example, purpose of use, to the sensor-enabled appliance. In embodiments, settings could be used to allow for the comparability of the appliances to be adjusted by a user, system administrator, or in another way, as appropriate. For example, an appliance could be identified as comparable based on purpose of use of the appliance, as well as brand, size, original cost, or other factors. In embodiments, the relational data from comparable appliances identified by the system could be used to calculate the current usage cost as well as the potential usage cost. For example, current usage costs for a two-year-old refrigerator could be calculated. In this calculation, a subset of relational data could be used. This subset of relational data could include hourly electrical consumption rates for a set of comparable appliances (e.g., similarly aged refrigerators in a two mile radius of the two-year-old refrigerator of interest. This subset of relational data could include the electrical consumption rates for the set of refrigerators over the lifetime of the refrigerators. This data could be analyzed and from the analysis, a determination could be made that on average the comparable refrigerators consume 5% less electricity in the months of September, October, and November. Assuming the determination was made in a month other than those impacted by the decrease, the 5% decrease could then be applied to the baseline current usage cost, in order to lower the predicted cost of the two-year-old refrigerator. Thus, relational data could be used to adjust and refine the current usage cost, by adjusting baseline numbers to account for discrepancies between the predicted rates (based on, e.g., outliers in the reported usage data from the appliance of interest, lack of data based on the small sample size—a single appliance, or others) and the realistic usage as identified by comparable appliances.

Similarly, the relational data could also be used in the determination of the potential usage costs. For example, the potential usage cost could be calculated using data including: current utilization rate of the appliance, electrical efficiency statistics about the new appliance from the appliance manufacturer, predicted life span of the new appliance (from e.g., an external website), and other data. The relational data may also be used in calculating the potential usage cost. For example, a set of users could be registered to a social media site. A subset of these users could also have recently registered a warranty or reviews on a particular appliance deemed comparable to one owned by a user in the set. The system could access data from registered comparable appliances (i.e., relational data), analyze the data, and determine the life span of the registered comparable appliances is 5 years shorter than the one listed on the external website. The system could then reduce the predicted life span in the potential usage cost accordingly (thus increasing the overall potential cost), and determine a more accurate potential usage cost.

Using the usage data for the sensor-enabled appliance, new appliance profile, and the relational data, the system may determine current usage costs exceed potential usage costs. In embodiments, usage costs may be a value or price associated with the use of the sensor-enabled appliance. For example, a fairly new refrigerator may cost ninety dollars per year in energy costs to run, and have no foreseeable repair requirements in the upcoming year. Thus, the usage cost for the refrigerator would be ninety dollars per year. The usage costs may also include expected maintenance costs of the sensor-enabled appliance. For example, if the appliance requires an annual repair or part replacement, this cost could be included in the current usage costs determination. In embodiments, potential usage costs could include predicted costs of using the new appliance (for example, a replacement refrigerator). Potential usage costs for a replacement refrigerator could include an energy cost of fifty dollars per year combined with the cost of the new refrigerator as applied based on predicted annual cost of refrigerator purchase (e.g., the price of the new refrigerator divided over the expected lifetime of the refrigerator). For example, a new refrigerator may cost $200 and be expected to last for ten years. Thus, the predicted annual cost of the new refrigerator purchase is twenty dollars. Thus, the potential usage cost for a replacement refrigerator in this example would be seventy dollars (fifty dollars plus twenty dollars). The system could make this determination and transmit the determination to a user device. The determination could be transmitted as an audio message, a text-based message, or another notification appropriate to the device. In embodiments, the user device may be a smart phone or wearable device owned by or associated with the user who owns the sensor-enabled appliance. In other embodiments, the determination may be transmitted to a user device associated with a retail user, an advertising user, or another device.

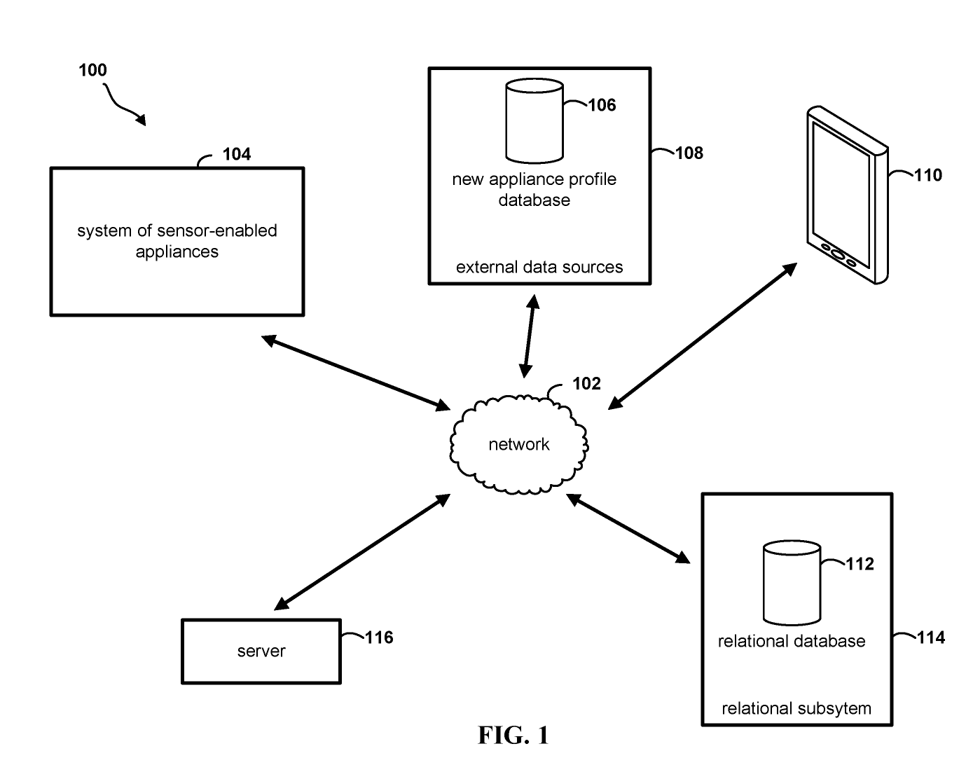

FIG. 1 depicts a diagram of a system 100 for notifying users of energy consumption data, according to embodiments. The system can be a computer server with at least one processor circuit configured to carry out a method detailed herein. In embodiments, a system of one or more sensor-enabled appliances 104 may communicate with a central server 116 over one or more networks 102. The networks 102 can be implemented using any number of any suitable communications media. For example, the network 102 may be a wide area network (WAN), a local area network (LAN), the Internet, or an intranet. In embodiments, the system of sensor-enabled appliances 104 may be, for example, a set of electric appliances within a household or set of households. The appliances could have microprocessors installed within them, and the microprocessors could monitor the energy usage and send this usage data to one or more central servers 116 over the network 102. In embodiments, the system of sensor-enabled appliances 104 may communicate over a network internal to a subsystem of sensor-enabled appliances 104. For example, appliances in a household may be networked over a secure wireless network in a home, apartment building, or other grouping that may be suitable. The server may access from one or more external data sources 108 a new appliance profile stored in a new appliance profile database 106.

The profiles stored within the new appliance profile database 106 may be compiled using data mining and/or natural language processing techniques in order to gather data from various location across the Internet, including manufacturer and retailer websites, consumer feedback and review websites, and other locations that may be suitable for gathering data relevant to determining qualities of a particular appliance, including usage costs, predicted malfunctions, repairs, and lifetime of the appliance, cost of a new and used appliance, energy usage trends and improvements, and other data.

In embodiments, the server 116 may also receive or access relational data from a relational database 112 which may be contained within a relational subsystem 114. The relational database 112 may contain relational data received by the server 116 from a system of sensor-enabled appliances 114 and sent to the relational subsystem 114. In embodiments, the relational subsystem 114 may access data from the system of sensor-enabled appliances 104, to be stored in a relational database 112. The relational data may be data collected from a set of sensor-enabled appliances belonging to a set of users associated with the user. In some embodiments, the set of users may be associated with the user (e.g., the current owner of the sensor-enabled appliance), and may be identified based on social media connections. For example, a user may be associated with the owner user based on a first or second degree connection on a social media platform. A user may be associated with an owner user based on geographic proximity of the owner user or of the user's sensor-enabled appliances. For example, neighbors in a neighborhood may be associated, based on geographic proximity of their homes (and the associated household sensor-enabled appliances). In another example, a set of users may be associated with the owner user based on demographic similarities like age, employment status, or household size.

In embodiments, one or more processor circuits of the server 116 may determine current usage costs associated with the sensor-enabled appliance exceed potential usage costs. Potential usage costs may be a predicted cost of using the new appliance over a particular period of time. This determination may be based on the usage data for the sensor-enabled appliance, the new appliance profile, and the identified relational data.

In embodiments, the relational data can be used to adjust the current usage costs. For example, the system can use the sensor-enabled appliance usage data as a baseline for the determination of current usage costs. The system could then factor in other data, including the relational data, in order to better predict the future costs of the current sensor-enabled appliance. For example, relational data could be used to correct the current usage predictions, by indicating that although the current usage costs extrapolated may indicate x level of usage, based on relational data indicating that in the particular geographical area, usage of the particular appliance drops significantly during the winter months, and thus the usage costs prediction for the current appliance could be adjusted downward. This adjustment could result in a more accurate prediction of the current usage costs.

Relational data could also be used to adjust the potential usage costs (e.g., the costs associated with the new appliance). For example, relational data could indicate actual usage and efficiency statistics for a new appliance as collected from comparable appliances used by persons demographically similar. These data could then be compared with the data in the new appliance profile (that was collected, for example, from a website of the new appliance manufacture). Based on this comparison, the potential usage costs could be adjusted.

This determination can then be transmitted to a user device 110. In embodiments, the user device 110 may be one owned by the user for whom the sensor-enabled appliance is being evaluated. In other embodiments, the user device 110 may be one associated with a user outside the system, for example, an advertising agency, marketing company, or retailer.

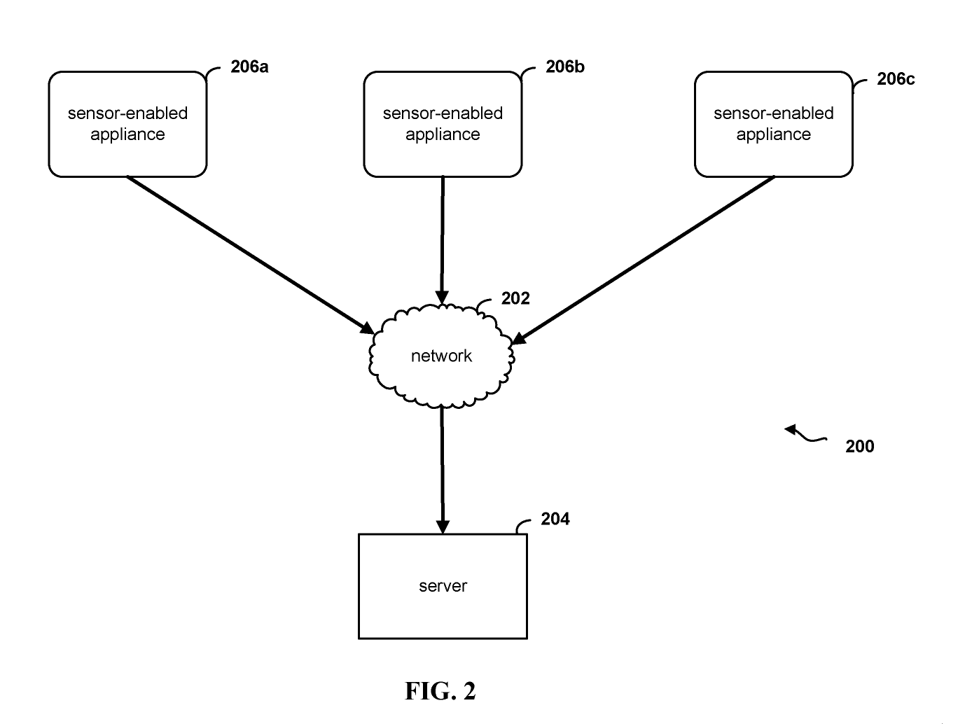

FIG. 2 depicts a diagram of a system 200 of sensor-enabled appliances, according to embodiments. In some embodiments, the system 200 may be a detailed figure of the system of sensor-enabled appliances 104 of FIG. 1. In other embodiments, the system 200 may be a combination of the system of sensor-enabled appliances 104, the network 102, and the server 116 all of FIG. 1. The network 102 of FIG. 1 being comparable to the network 202 of FIG. 2, and the server 116 of FIG. 1 being comparable to the server 204 of FIG. 2.

In embodiments, a group of sensor enabled appliances 206 may each have a microprocessor installed within them that monitors the energy usage and may be connected to one or more servers 204 over a network 202. The server 204 could log the current time (e.g., if energy costs are different at different times of the day), a period of time the sensor-enabled appliances 206 were running, and the total energy consumed. Over time, data can build at the server and the server can develop usage trends to more accurately analyze the cost of use for the appliance. These trends may change according to time of year, time of day, or other variables. For example, an air conditioner may be used more often during warmer months, but it may consume minimal electricity during the winter months.

In some cases, the sensor-enabled appliances 206 may each be an appliance in a single household. In other embodiments, sensor-enabled appliances 206a and 206b may be located in a single household and sensor-enabled appliance 206c may be located in a second household. These two homes may be related based on a common user (e.g., the first home being a primary residence of the user and the second being a vacation residence), a shared geography (e.g., both homes located within the same block or geographic radius), or in other way.

In embodiments, and as suitable for the system 200, the network 202 may be one of a variety of networks. For example, if all sensor-enabled appliances 206 are located within a same home or building, the network could be a secure wireless connection, in order to allow sensor-enabled appliance 206a to communicate securely and directly with both sensor-enabled appliances 206b and 206c, as well as the server 204. In other embodiments, the network may be a public network or a private network with varying levels of priority, in order to allow sensor-enabled appliances 206 to communicate among each other and with the server 204, even when located in different geographic locations.

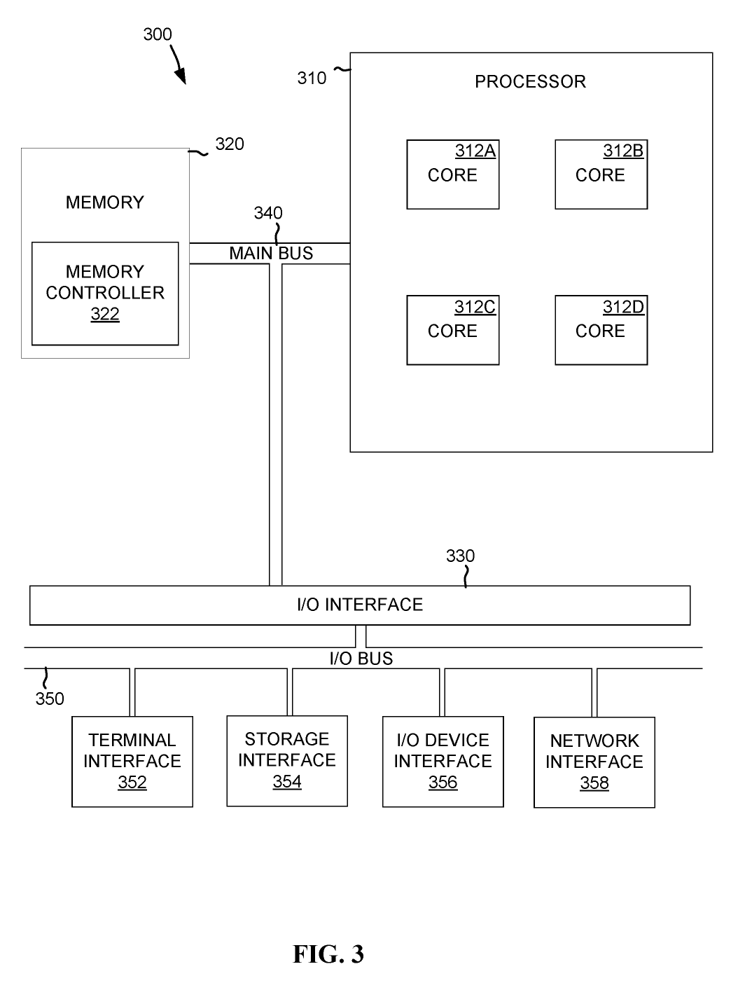

FIG. 3 depicts the representative major components of an example computer system 300 that may be used, in accordance with embodiments of the present disclosure. It is appreciated that individual components may vary in complexity, number, type, and\or configuration. The particular examples disclosed are for example purposes only and are not necessarily the only such variations. The computer system 300 may comprise a processor 310, memory 320, an input/output interface (herein I/O or I/O interface) 330, and a main bus 340. The main bus 340 may provide communication pathways for the other components of the computer system 300. In some embodiments, the main bus 340 may connect to other components such as a specialized digital signal processor (not depicted).

The processor 310 of the computer system 300 may be comprised of one or more cores 312A, 312B, 312C, 312D (collectively 312). The processor 310 may additionally include one or more memory buffers or caches (not depicted) that provide temporary storage of instructions and data for the cores 312. The cores 312 may perform instructions on input provided from the caches or from the memory 320 and output the result to caches or the memory. The cores 312 may be comprised of one or more circuits configured to perform one or methods consistent with embodiments of the present disclosure. In some embodiments, the computer system 300 may contain multiple processors 310. In some embodiments, the computer system 300 may be a single processor 310 with a singular core 312.

The memory 320 of the computer system 301 may include a memory controller 322. In some embodiments, the memory 320 may comprise a random-access semiconductor memory, storage device, or storage medium (either volatile or non-volatile) for storing data and programs. In some embodiments, the memory may be in the form of modules (e.g., dual in-line memory modules). The memory controller 322 may communicate with the processor 310, facilitating storage and retrieval of information in the memory 320. The memory controller 322 may communicate with the I/O interface 330, facilitating storage and retrieval of input or output in the memory 320.

The I/O interface 330 may comprise an I/O bus 350, a terminal interface 352, a storage interface 354, an I/O device interface 356, and a network interface 358. The I/O interface 330 may connect the main bus 340 to the I/O bus 350. The I/O interface 330 may direct instructions and data from the processor 310 and memory 320 to the various interfaces of the I/O bus 350. The I/O interface 330 may also direct instructions and data from the various interfaces of the I/O bus 350 to the processor 310 and memory 320. The various interfaces may include the terminal interface 352, the storage interface 354, the I/O device interface 356, and the network interface 358. In some embodiments, the various interfaces may include a subset of the aforementioned interfaces (e.g., an embedded computer system in an industrial application may not include the terminal interface 352 and the storage interface 354).

Logic modules throughout the computer system 300—including but not limited to the memory 320, the processor 310, and the I/O interface 330—may communicate failures and changes to one or more components to a hypervisor or operating system (not depicted). The hypervisor or the operating system may allocate the various resources available in the computer system 300 and track the location of data in memory 320 and of processes assigned to various cores 312. In embodiments that combine or rearrange elements, aspects and capabilities of the logic modules may be combined or redistributed. These variations would be apparent to one skilled in the art.

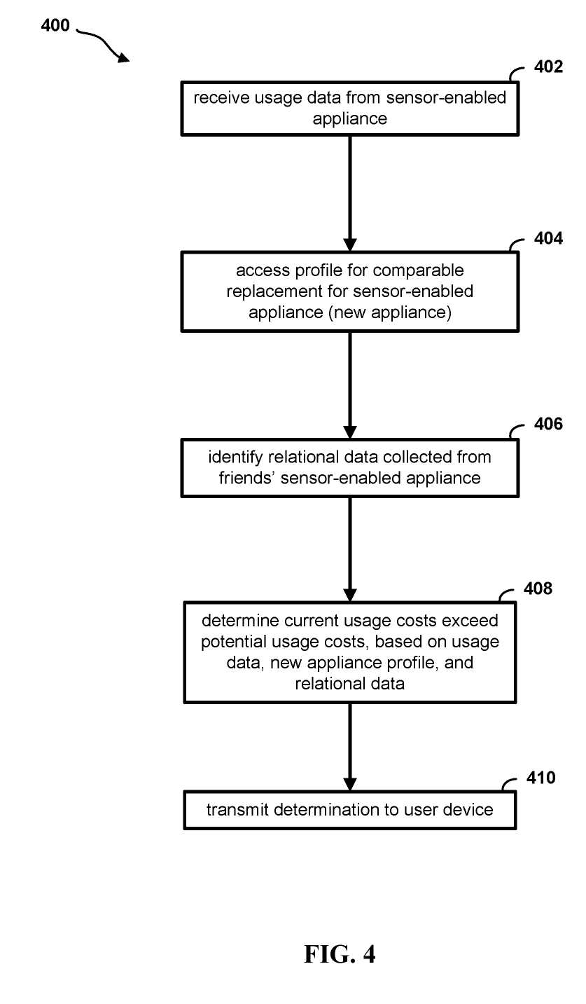

FIG. 4 depicts a flow diagram of a method 400 for notifying users of sensor-enabled appliance energy consumption, according to embodiments. The method 400 may begin when a system receives usage data from a sensor-enabled appliance, per 402. In embodiments, the system may be the one or more servers 116 of FIG. 1. This data can include raw electrical consumption data. It also may be processed using, for example, natural language processing or text analytics, in order to identify usage trends for the particular appliance or analyze power consumption for each appliance. The processing may also aggregate an average cost of use for the appliance by taking into account current costs of electricity, as well as use the raw usage data to monitor the health of the appliance to predict the cost of repair. This and other data can be included in the usage data received at 402.

The system can then access a profile for a comparable replacement for the sensor-enabled appliance. In embodiments, this may be a new appliance, or a replacement appliance, to replace the sensor-enabled appliance. In embodiments, the profile may be created by mining a set of one or more databases for price data for a particular retailer of the new appliance. In embodiments, the database(s) may contain data from various online and brick-and-mortar retailers, including current and upcoming sales, sales trends for the particular appliance, or other data. The mining may be conducted relative to the sensor-enabled appliance, ensuring that the data collected from the databases on the new appliance is for an appliance comparable to the sensor-enabled appliance. The profile may also be created by mining a set of databases for energy consumption of the new appliance. For example, a set of databases could include product reviews, manufacturer data, third-party test data, or other data that may be relevant to determining the usage cost or energy usage of the new appliance. This data could then be stored in the profile for the new appliance.

The system could then identify relational data collected from sensor-enabled appliances of ‘friends’ or other users associated with the owner or user of the sensor-enabled appliance of interest, as described herein, per 406. This relational data could be processed using natural language processing or textual analytics or in another way in order to acquire more detailed usage information, including usage changes between old and new appliances, usage trends over a predetermined period of time, usage trends for particular demographics, or other data that could be relevant to the system's determination.

The system could then determine that current usage costs exceed potential usage costs, per 408. This determination may be based on the identified usage data, the accessed new appliance profile, and the identified relational data. In embodiments, the system may use other data in making this determination, including, for example, a determination of the period of time it will take to pay off the new appliance, a determined cost of installation, an installation time requirement, or other data deemed useful in determining that the usage costs of the current sensor-enabled appliance are higher than a replacement one.

The system could then transmit this determination to a user device, per 410. The determination could be transmitted to the user device in order to cause the user device to alert a user in some way. For example, the transmittal could cause the user device to display a text-based message, to ring or buzz, to vibrate, light a screen on the device, or respond in another way. The transmittal could also cause the user device to notify another device, an online retailer (e.g., to automatically purchase the new appliance), another third-party, or device within another system.

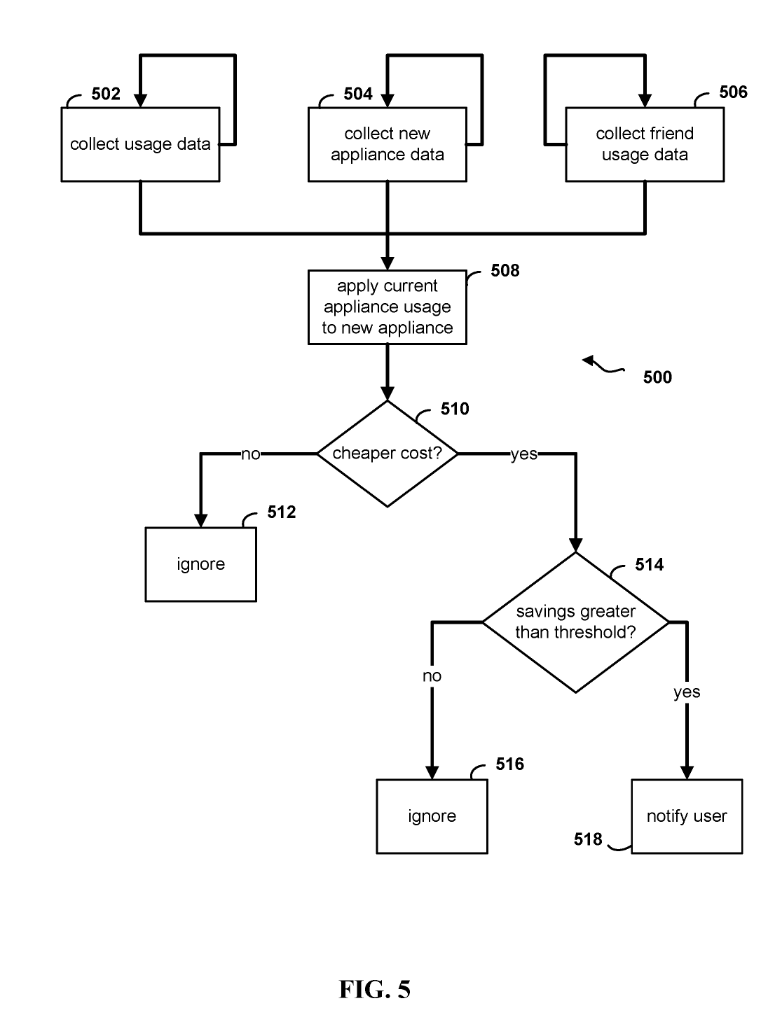

FIG. 5 depicts a flow diagram of a method 500 for notifying a user of a sensor-enabled appliance, based on usage data, appliance data, and friend usage, according to embodiments. The method 500 may begin when usage data, as described herein, is collected, per 502. New appliance data can also be collected, per 504. As described herein, this data may be provided to the system via a new appliance profile. The system can allow collection of relational data (e.g., friend usage data), per 506, from a group of sensor-enabled devices (e.g., one or more appliances on the internet of things). This data can then be used by the system, to apply the current appliance usage to that of a new appliance, per 508. If the cost of the current appliance is cheaper than that of the new appliance, per 510, then the system can ignore the determination, per 512. If the system determines at 510 that the cost of a new appliance is less than that of the current appliance, the system can then evaluate whether or not the savings are above a predetermined threshold, per 514, then the system can notify the user, per 518, as described herein. If the savings do not exceed the threshold at 514, the system may ignore the determination, per 516.

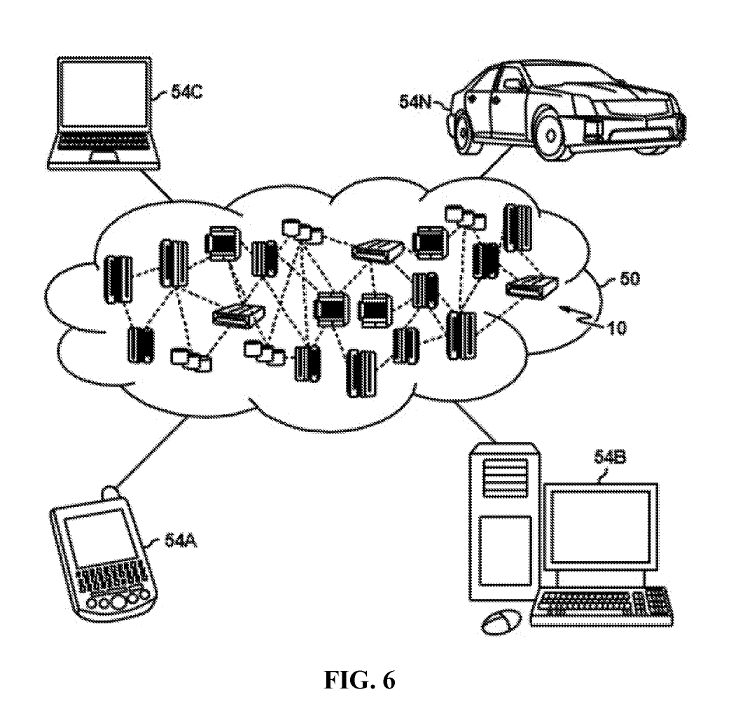

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

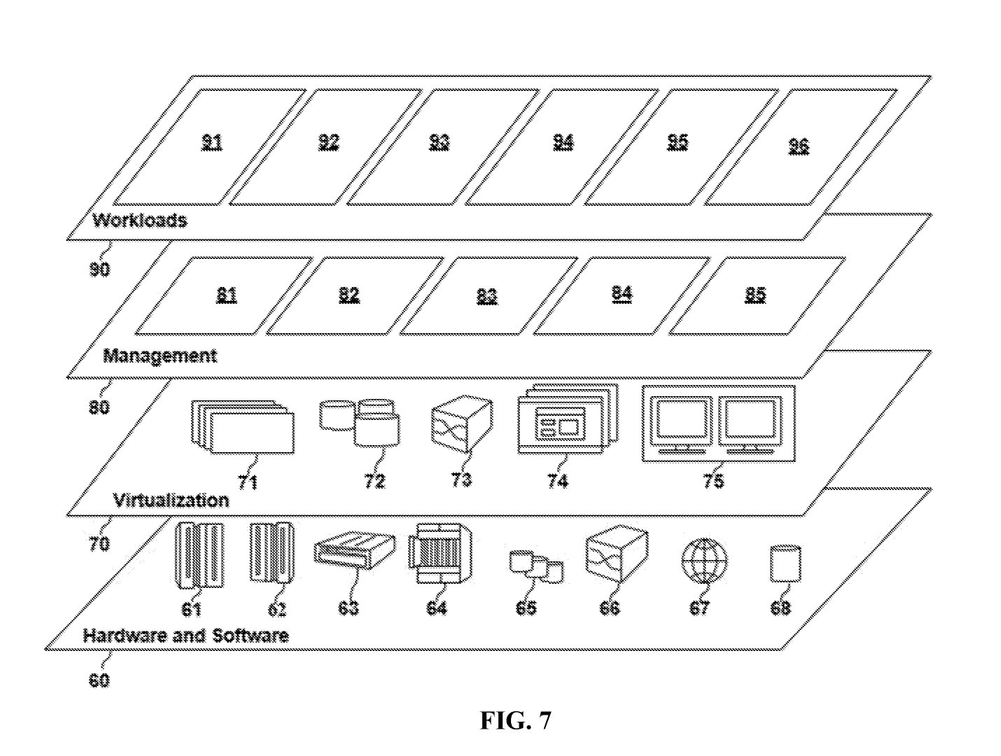

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and notifying a user device of sensor-enabled appliance usage 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
receiving, at a server and from a first sensor-enabled appliance, usage data for the first sensor-enabled appliance, the first sensor-enabled appliance associated with a user;
accessing, from an external data source, a new appliance profile, the new appliance profile comprising price and energy consumption data about the new appliance;
identifying relational data, wherein relational data comprises data collected from a set of sensor-enabled appliances belonging to a set of users associated with the user;
determining, based on the usage data for the first sensor-enabled appliance, the new appliance profile, and the relational data, current usage costs exceed potential usage costs, wherein current usage cost is a value associated with use of the first sensor-enabled appliance over a period of time and the potential usage cost is a predicted cost of using the new appliance; and
transmitting, to a user device, the determination that current usage costs exceed potential usage costs.

2. The method of claim 1, wherein the relational data is collected by:
identifying, using social media networks, the set of users associated with the user, wherein the set of users is associated with the user based on degrees of connection over one or more of the social media networks;
identifying, for each user in the set of users, the set of sensor-enabled appliances belonging to each user in the set of users;
detecting, from the set of sensor-enabled appliances, one or more comparable appliances, the comparable appliances being comparable to the first sensor-enabled appliance; and
collecting, from the one or more comparable appliances, relational data, the relational data comprising usage data for each of the one or more comparable appliances.

3. The method of claim 2, wherein the first sensor-enabled appliance is a particular household appliance of a particular brand, and wherein the one or more comparable appliances are a set of the particular household appliance of a brand other than the particular brand.

4. The method of claim 1, wherein the external data source comprises a set of data processed by a natural language processing system.

5. The method of claim 1, wherein the transmitting to the user device causes the user device to alert a user via a text-based notification.

6. The method of claim 1, further comprising:
mining, relative to the first sensor-enabled appliance, a database for price data for a particular retailer of the new appliance;
mining, relative to the sensor-enabled appliance, a database for energy consumption data for the new appliance; and
storing, in the new appliance profile, the price data for the particular retailer and the energy consumption data for the new appliance.

7. The method of claim 1, wherein the usage data comprises power consumption data for the first sensor-enabled appliance.

8. The method of claim 1, wherein the current usage costs further comprise expected maintenance costs for the first sensor-enabled appliance.

9. A system comprising:
a computer readable storage medium with program instructions stored thereon; and
one or more processors configured to execute the program instructions to perform a method comprising:
receiving, at a server and from a first sensor-enabled appliance, usage data for the first sensor-enabled appliance, the first sensor-enabled appliance associated with a user;
accessing, from an external data source, a new appliance profile, the new appliance profile comprising price and energy consumption data about the new appliance;
identifying relational data, wherein relational data comprises data collected from a set of sensor-enabled appliances belonging to a set of users associated with the user;
determining, based on the usage data for the first sensor-enabled appliance, the new appliance profile, and the relational data, current usage costs exceed potential usage costs, wherein current usage cost is a value associated with use of the first sensor-enabled appliance over a period of time and the potential usage cost is a predicted cost of using the new appliance; and
transmitting, to a user device, the determination that current usage costs exceed potential usage costs.

10. The system of claim 9, wherein the one or more processors are further configured to collect relational data by:
identifying, using social media networks, the set of users associated with the user, wherein the set of users is associated with the user based on degrees of connection over one or more of the social media networks;
identifying, for each user in the set of users, the set of sensor-enabled appliances belonging to each user in the set of users;
detecting, from the set of sensor-enabled appliances, one or more comparable appliances, the comparable appliances being comparable to the first sensor-enabled appliance; and
collecting, from the one or more comparable appliances, relational data, the relational data comprising usage data for each of the one or more comparable appliances.

11. The system of claim 10, wherein the first sensor-enabled appliance is a particular household appliance of a particular brand, and wherein the one or more comparable appliances are a set of the particular household appliance of a brand other than the particular brand.

12. The system of claim 9, wherein the external data source comprises a set of data processed by a natural language processing system.

13. The system of claim 9, wherein the transmitting to the user device causes the user device to alert a user via a text-based notification.

14. The system of claim 9, wherein the method further comprises:
mining, relative to the first sensor-enabled appliance, a database for price data for a particular retailer of the new appliance;
mining, relative to the sensor-enabled appliance, a database for energy consumption data for the new appliance; and
storing, in the new appliance profile, the price data for the particular retailer and the energy consumption data for the new appliance.

15. The system of claim 9, wherein the usage data comprises power consumption data for the first sensor-enabled appliance.

16. The system of claim 9, wherein the current usage costs further comprise expected maintenance costs for the first sensor-enabled appliance.

17. A computer program product comprising a computer readable storage medium having program instructions embodied therewith wherein the computer readable storage medium is not a transitory signal per se, the program instructions executable by a computer processing circuit to cause the circuit to perform a method comprising:
receiving, at a server and from a first sensor-enabled appliance, usage data for the first sensor-enabled appliance, the first sensor-enabled appliance associated with a user;
accessing, from an external data source, a new appliance profile, the new appliance profile comprising price and energy consumption data about the new appliance;
identifying relational data, wherein relational data comprises data collected from a set of sensor-enabled appliances belonging to a set of users associated with the user;
determining, based on the usage data for the first sensor-enabled appliance, the new appliance profile, and the relational data, current usage costs exceed potential usage costs, wherein current usage cost is a value associated with use of the first sensor-enabled appliance over a period of time and the potential usage cost is a predicted cost of using the new appliance; and
transmitting, to a user device, the determination that current usage costs exceed potential usage costs.

18. The computer program product of claim 17, wherein the external data source comprises a set of data processed by a natural language processing system.

19. The computer program product of claim 17, wherein the transmitting to the user device causes the user device to alert a user via a text-based notification.

20. The computer program product of claim 17, wherein the method further comprises:
mining, relative to the first sensor-enabled appliance, a database for price data for a particular retailer of the new appliance;
mining, relative to the sensor-enabled appliance, a database for energy consumption data for the new appliance; and
storing, in the new appliance profile, the price data for the particular retailer and the energy consumption data for the new appliance.
